(19) United States
(12) Patent Application Publication
(10) Pub. No.: US 2005/0257212 A1
(43) Pub. Date: Nov. 17, 2005

(54) System and method for autonomic software delivery for personal area networks

(75) Inventors: Ryan Alexander Boyles, Raleigh, NC (US); Joseph Eric Firebaugh, Apex, NC (US); Robert Charles Leah, Cary, NC (US); Paul Franklin McMahan, Apex, NC (US)

Correspondence Address: VAN LEEUWEN & VAN LEEUWEN, P.O. BOX 90609, AUSTIN, TX, 78709-0609, US

(73) Assignee: International Business Machines Corporation, Armonk, NY (US)

(21) Appl. No.: 10/845,870

(22) Filed: May 14, 2004

(51) Int. Cl. G06F 9/44

(52) U.S. Cl. 717/170

(57) ABSTRACT

A system and method for autonomic software delivery for personal area networks is presented. A software installer is included in a responding device that uses a device profile table to identify the capabilities of a requesting device. Once identified, the responding device provides software data, such as software identifiers and versions, to the requesting device. The requesting device compares its installed software with the software data it received from the responding device. In turn, the requesting device downloads software from the responding device that it either does not have or is outdated. Once the requesting device downloads the software, the requesting device may send requests, such as a print request or a remote control command, to the responding device using the downloaded software.

### BACKGROUND OF THE INVENTION

1. Technical Field

The present invention relates in general to a system and method for autonomic software delivery for personal area networks. More particularly, the present invention relates to a system and method for exchanging software between wireless devices which allows the wireless devices to effectively communicate with each other.

2. Description of the Related Art

Electronic devices are incorporating technology which allows them to communicate with other electronic devices in an ad-hoc network, such as a personal area network. A personal area network (PAN) interconnects electronic devices within a short distance (e.g. 10 meters). For example, a person traveling with a laptop computer, a personal digital assistant (PDA), and a portable printer is able to interconnect the devices using a PAN instead of using wires. In addition, PAN's may be wirelessly interconnected to other networks, such as the Internet.

Bluetooth technology is becoming increasingly popular for establishing personal area device-to-device ad-hoc networks. Bluetooth is a telecommunications industry standard whereby devices in a PAN share a common communication data channel. The channel has a total capacity of 1 megabit per second (Mbps). Headers and handshaking information consume about 20 percent of this capacity. The Bluetooth frequency range is 2.4 to 2.4835 GHz, with 79 1-MHz radio frequency (RF) channels. Each data channel hops randomly 1,600 times per second between the 79 RF channels.

A challenge found with communicating between wireless devices in a PAN, however, is that application software and software drivers for communicating with other wireless devices are manually installed prior to establishing the PAN. For example, a PDA may establish an ad-hoc network with a printer. In this example, once the ad-hoc network is established, the PDA must have an appropriate printer driver in order for the PDA to use the printer.

In addition, another challenge found with wireless devices is consistently updating software versions for the applications software and the software drivers. Since the wireless devices are typically mobile, the wireless devices may not have up-to-date software to communicate with other wireless devices. For example, a wireless device may come with pre-installed software drivers, and its user may never update the software drivers. In turn the user's wireless device may not operate correctly using outdated software, or the user's wireless device may not have appropriate drivers to communicate with newer wireless devices.

What is needed, therefore, is a system and method for exchanging software between wireless devices in an ad-hoc network that allows the wireless devices to effectively communicate with each other.

### SUMMARY

It has been discovered that the aforementioned challenges are resolved by using “software installers” that are embedded in each wireless device to manage and exchange software between wireless devices that are included in an ad-hoc network. A responding device's software installer provides software downloads to a requesting device that requires up-to-date software. In turn, the requesting device uses the downloaded software to communicate with the responding device.

A responding device and a requesting device establish a personal area network (PAN) connection using standard PAN communication techniques. Once the PAN is established, the requesting device may wish to communicate with the responding device using up-to-date software. For example, the requesting device may be a personal digital assistant that is capable of remotely controlling a television (e.g. the responding device) using particular interface software. Both the requesting device and the responding device include a “software installer” which manages software that is installed on their respective devices, as well as managing software downloads/uploads from/to other devices.

The requesting device sends a query to the responding device, which requests that the responding device provide “software data”, such as software names and versions, that the requesting device may use for communicating with the responding device. The responding device receives the query, and identifies software data that corresponds to the requesting device's capabilities. During the identification process, the responding device's software installer identifies the requesting device's capabilities and identifies software identifiers and versions that correspond to the requesting device's capabilities. The responding device sends the software data to the requesting device. Using the example described above, the television identifies application software and its corresponding version that the PDA may use to remotely control the television.

The requesting device receives the software data, and determines which software to download by matching the software data with software it already has installed. When the requesting device identifies software it wishes to download, the requesting device sends a download request to the responding device. The responding device retrieves the software from its software storage area, and sends the software to the requesting device. The requesting device loads the software and uses it when it communicates with the responding device.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing two devices discovering each other in a personal area network and a responding device sending software to a requesting device in order for the requesting device to communicate with the responding device;

FIG. 2A is a device profile table showing device capability entries;

FIG. 2B is a version control table showing installed software and their versions that correspond to particular devices;

FIG. 3 is a high-level flowchart showing steps taken in two devices discovering each other and a responding device sending driver software to a requesting device in order for the requesting device to communicate with the responding device;

FIG. 4 is a flowchart showing steps taken in a responding device identifying software that corresponds to a requesting device, and the responding device sending software data to the requesting device;

FIG. 5 is a detail level flowchart showing steps taken in a requesting device identifying and downloading software from a responding device; and

FIG. 6 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

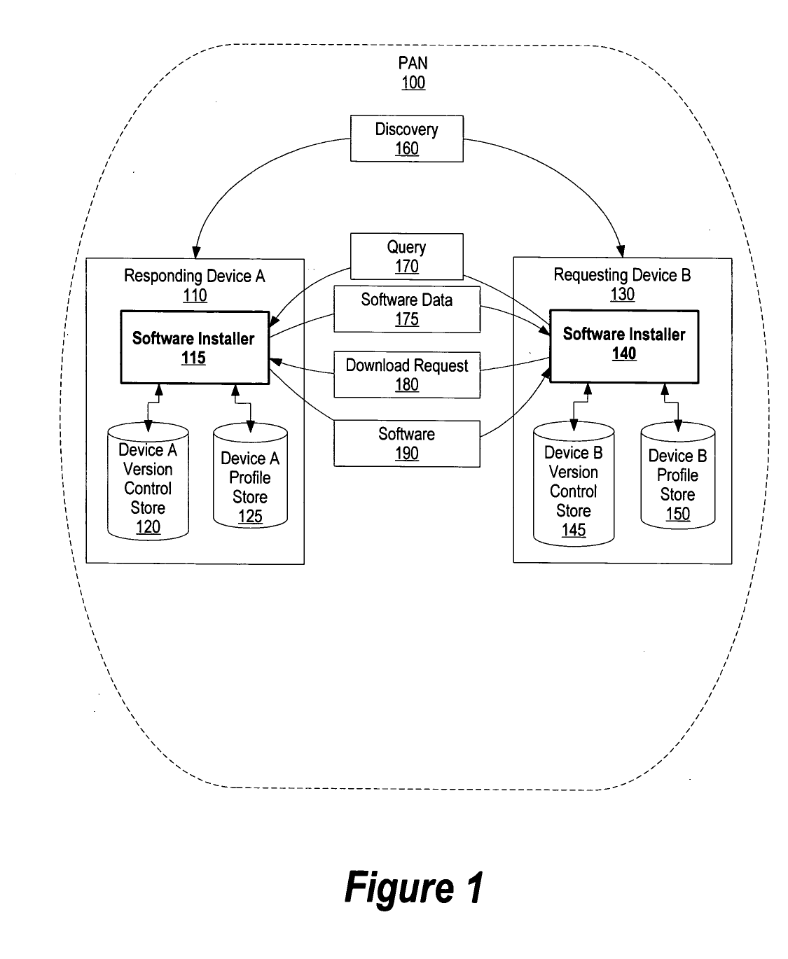

FIG. 1 is a diagram showing two devices discovering each other in a personal area network and a responding device sending software to a requesting device in order for the requesting device to communicate with the responding device. Two devices, responding device A 110 and requesting device B 130, are included in personal area network (PAN) 100, whereby PAN 100 may be a standard wireless network, such as Bluetooth. When the two devices are in proximity to each other, the two devices discover each other (e.g. discover 160) using communication techniques that are standard to PAN 100.

Once the two devices discover each other, requesting device B 130 may wish to communicate with responding device A 110. For example, requesting device B 130 may be a personal digital assistant, which is capable of remotely controlling responding device A 110 (i.e. a television). Requesting device B 130 includes software installer 140 which manages software that is installed in requesting device B 130. Software installer 140 uses a version control table that is located in device B version control store 145 and a profile table that is located in device B profile store 150 to manage software downloads/uploads from/to other devices. Requesting device B 130 sends query 170 to responding device A 110 which requests responding device A 110 to send software data that includes software identifiers and versions that requesting device B 130 may use in order to communicate with responding device A 110.

Responding device A 110 receives query 170, and identifies software identifiers and their versions that correspond to requesting device B 130. During the identification process, responding device A 110 uses software installer 115 to identify requesting device B 130's capabilities by accessing a device profile table that is located in device A profile store 125. In addition, software installer 115 accesses a version control table that is located in device A version control store 120 to identify software identifiers and versions that correspond to the requesting device's capabilities.

Responding device A 110 sends software data 175 to requesting device B 130 that includes software identifiers and their corresponding versions. Requesting device B 130 receives software data 175, and determines which software to download by accessing its version control table that is located in version control store 145. When requesting device B 130 identifies software it wishes to download, requesting device B 130 sends download request 180 to responding device A 110. In turn, responding device A 110 sends software 190 to requesting device B 130 which it uses when communicating with responding device A 110.

In one embodiment, responding device A 110 receives software data from requesting device B 130. In this embodiment, responding device A 110 performs the determination step as to which software to provide to requesting device B 130, such as which software requires an updated version.

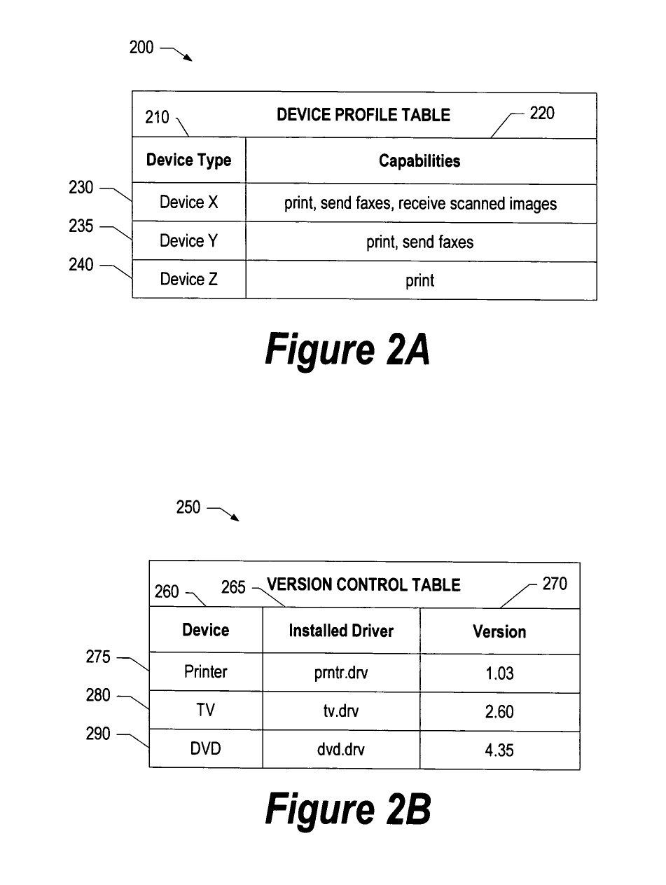

FIG. 2A is a device profile table showing device capability entries. A responding device uses table 200 to identify a requesting device's capabilities when it receives a query from the requesting device. For example, a printer may receive a query from a personal digital assistant (PDA) whereby the printer identifies that the PDA has printing and faxing capability.

Table 200 includes columns 210 and 220. Column 210 includes a list of device types, such as “PDA”, “laptop computer”, and “cell phone”. Column 220 includes a list of capabilities that correspond to the device types that are included in column 210. Rows 230 through 240 are device capability entries that correspond to particular device types. Row 230 includes a device type “device X” whereby its corresponding capabilities are printing, sending faxes, and receiving scanned images. Row 235 includes a device type “device Y” whereby its corresponding capabilities are printing and sending faxes. Row 240 includes a device type “device Z” whereby its corresponding capability is printing. A responding devices uses the requesting devices capabilities in the process of identifying which software the requesting device may use in order to communicate to the responding device.

FIG. 2B is a version control table showing installed software and their versions that correspond to particular devices. A responding device uses version control entries that are included in table 250 in order to identify software identifiers and their corresponding versions that a requesting device may use in order to communicate with the responding device.

Table 250 includes columns 260 through 270. Column 260 includes a list of device types that may request software data from the responding device. Column 265 includes a list of software identifiers that correspond to the devices that are listed in column 260. Column 270 includes a list of versions that correspond to the software identifiers that are included in column 265.

Rows 275 through 290 are version control entries that correspond to particular devices. Row 275 shows that “printer” devices may use a “prntr.drv” software with a version “1.03” in order to communicate with a responding device. Row 280 shows that “TV” devices may use a “tv.exe” software with a version “2.60” in order to communicate with a responding device. Row 290 shows that “DVD” devices may use a “dvd.drv” software with a version “4.35” in order to communicate with a responding device.

In one embodiment, a first device may query a second device to see if the second device is capable of using a particular driver or software. In this embodiment, the first device may then query the second device to identify whether the second device already has the particular driver or software. In this embodiment, the first may record the second device ID's to signify that the second device has the software and, during negotiations, it sees that it has already offered the software or driver to the second device and it may quickly end the negotiation.

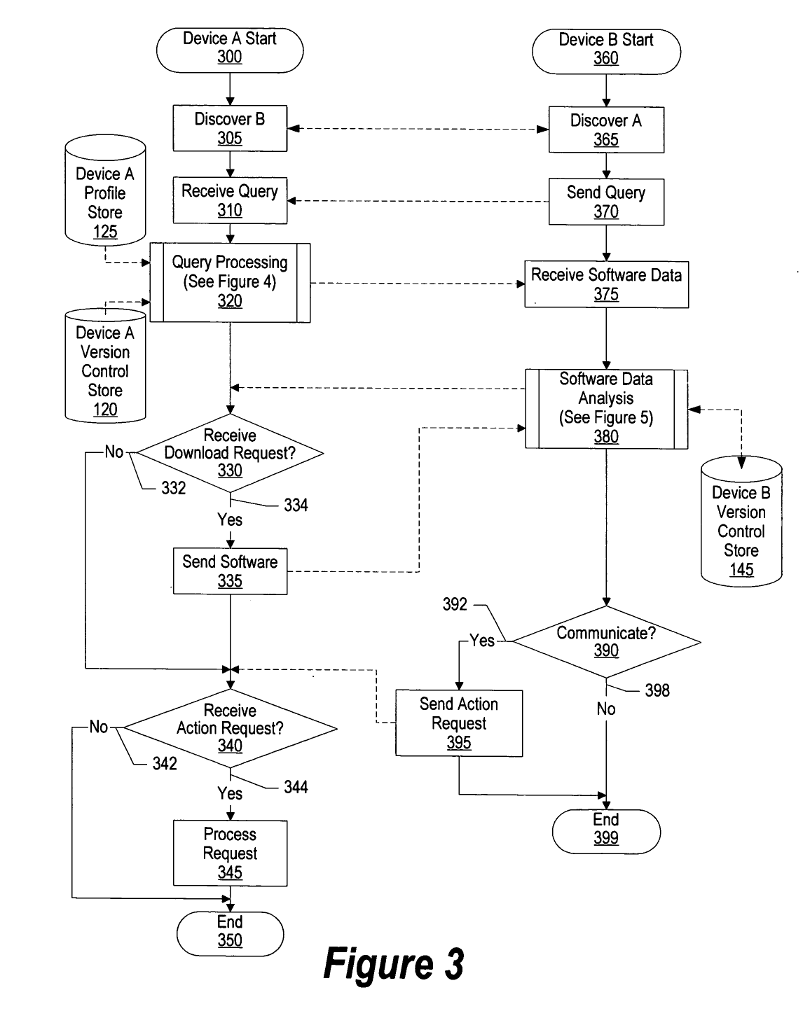

FIG. 3 is a high-level flowchart showing steps taken in two devices discovering each other and a responding device sending driver software to a requesting device in order for the requesting device to communicate with the responding device. Device A processing commences at 300, whereupon device A discovers device B at step 305. Similarly, device B processing commences at 360, whereupon device B discovers device A at step 365. The discovery process is performed using standard personal area network techniques, such as those found in Bluetooth.

Device B sends a query to device A at step 370, whereby the query includes a request for device A to identify software that device B may use in order to communicate with device A. For example, device B may be a PDA and wish to print a document to device A which is a printer. In this example, device B may require an updated printer driver to communicate with device A.

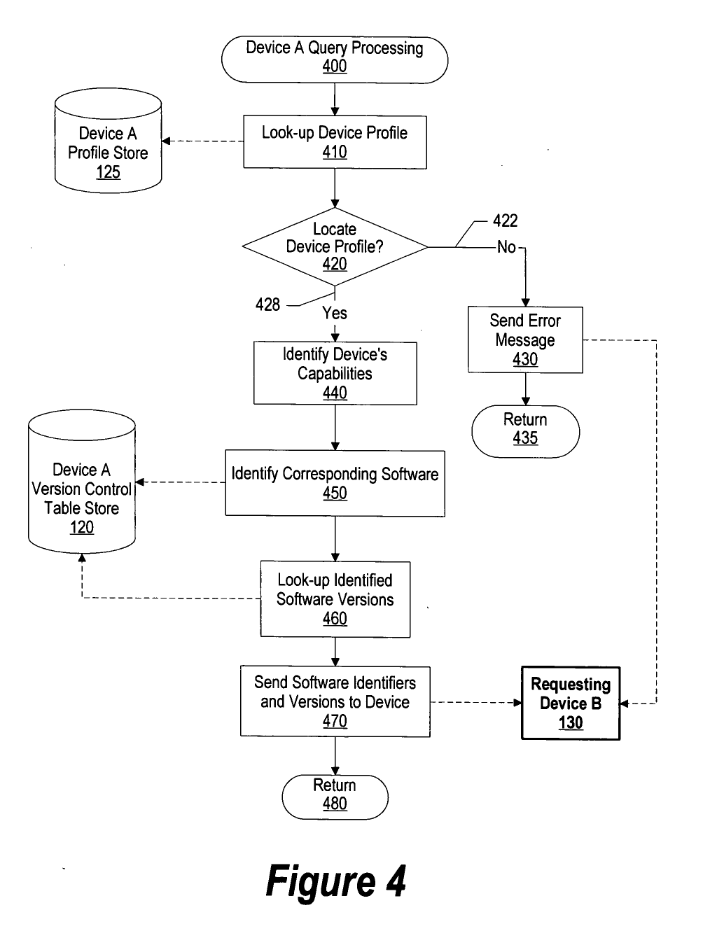

Device A receives device B's query at step 310, and proceeds to process the query by using a profile table located in device A profile store 125 in order to identify device B's device type. Device A also uses a version control table located in device A version control store 120 in order to identify software identifiers and versions that correspond to device B's capabilities (pre-defined process block 320, see FIG. 4 and corresponding text for further details). Device A profile store 125 and device A version control store 120 are the same as that shown in FIG. 1, and may be stored on a nonvolatile storage area, such as a computer hard drive.

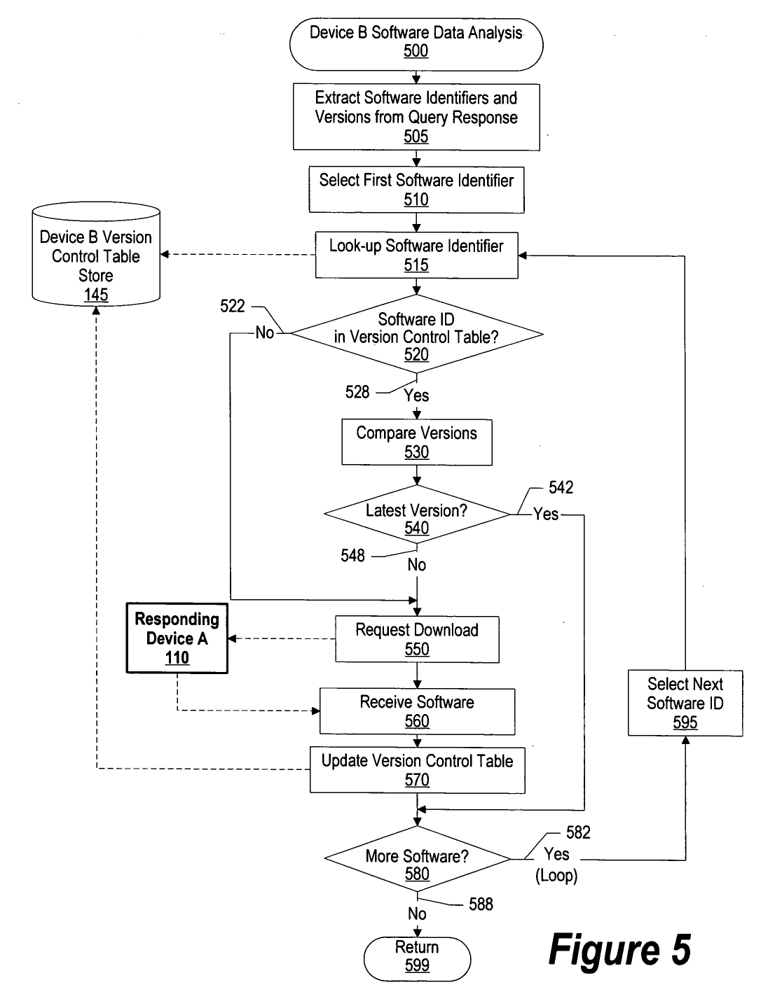

Device B receives software data from device A at step 375. The software data includes software identifiers and their corresponding versions in which device B may use to communicate with device A. Using the example described above, the software data may include a software identifier “”printerA.drv” and include its corresponding version. “1.0.6.” Device B analyzes the software data using version control entries that are included in device B version control store 145. Each version control entry includes a device name, a corresponding software identifier, and a corresponding software version (see FIG. 2B and corresponding text for further details regarding software version entry properties). When device B identifies software that it requires, or software that requires updating, device B sends a download request to device A (pre-defined process block 380, see FIG. 5 and corresponding text for further details). Device B version control store 145 is the same as that shown in FIG. 1, and may be stored on a nonvolatile storage area, such as a computer hard drive.

Device A determines whether device B wishes to download software (decision 330). If device B does not wish to download software, decision 330 branches to “No” branch 332 whereupon device A processing bypasses software downloading steps. On the other hand, if device B does wish to download software, decision 330 branches to “Yes” branch 334 whereupon device A sends the requested software to device B at step 335.

Device B determines whether it wishes to communicate with device A (decision 390). For example, a PDA may wish to send a print request to a printer. If device B wishes to communicate with device A, decision 390 branches to “Yes” branch 392 whereupon device B sends an action request to device A at step 395. On the other hand, if device B does not wish to communicate with device A, decision 390 branches to “No” branch 398 bypassing communication steps. Device B processing ends at 399.

Device A determines whether device B sent an action request, such as a print request (decision 340). If device B sent an action request, decision 340 branches to “Yes” branch 344 whereupon device A processes the action request at step 345. On the other hand, if device B did not send an action request, decision 340 branches to “No” branch 342 bypassing action request processing steps. Device A processing ends at 350.

FIG. 4 is a flowchart showing steps taken in a responding device identifying software that corresponds to a requesting device, and the responding device sending software data to the requesting device. Device A query processing commences at 400, whereupon processing looks up a requesting device's profile (e.g. requesting device B 130) in a device profile table located in device A profile store 125. The device profile table includes device capability entries that identify a requesting device's capabilities, such as printer capability and faxing capability (see FIG. 2A and corresponding text for further details regarding device profile table properties). Device A profile store 125 is the same as that shown in FIG. 1 and may be stored on a nonvolatile storage area, such as a computer hard drive.

A determination is made as to whether processing located a profile entry that corresponds to the requesting device (decision 420). For example, the requesting device may be a device type that the responding device has not encountered. If processing did not located a profile entry that corresponds to the requesting device, decision 420 branches to “No” branch 422 whereupon processing sends an error message to requesting device B 130, and processing returns at 435. Requesting device B 130 is the same as that shown in FIG. 1.

On the other hand, if processing did locate a device profile that corresponds to the requesting device, decision 420 branches to “Yes” branch 428 whereupon processing identifies the requesting device's capabilities using the located device profile entry (step 440). At step 450, processing identifies software that corresponds to the requesting device's capabilities by using a version control table that is located in device A version control table store 120. For example, if the requesting device has faxing capability, processing identifies a software driver in which the requesting device may use for sending a fax through device A. Device A version control table store 120 is the same as that shown in FIG. 1 and may be stored on a nonvolatile storage area, such as a computer hard drive.

Processing also identifies versions that correspond to the identified software (step 460). Versions are identified in order for the requesting device to determine whether it has the most recent software version (see FIG. 5 and corresponding text for further details regarding software update steps). Device A sends the software identifiers and their corresponding versions to requesting device B 130 at step 470, and returns at 480.

FIG. 5 is a detail level flowchart showing steps taken in a requesting device identifying and downloading software from a responding device. Processing commences at 500, whereupon device B extracts software identifiers and corresponding versions from a query response it received from a responding device, such as responding device A 110 (step 505). The query response includes one or more software identifiers and also includes one or more software versions that correspond to the software identifiers. Responding device A 110 is the same as that shown in FIG. 1.

Processing selects a first software identifier at step 510, and looks up the selected software identifier in a version control table that is located in device B version control table store 145 (step 515). The version control table has version control entries that include existing software identifiers and existing software versions (see FIG. 2B and corresponding text for further details regarding software version entry properties).

A determination is made as to whether one of the existing software identifiers matches the selected software identifier that was extracted from the query response (decision 520). If the extracted software identifier does not match one of the software version entries, decision 520 bypasses version comparison steps, and sends a download request to responding device A 110 at step 550.

On the other hand, if the extracted software identifier matches one of the software version entries, decision 520 branches to “Yes” branch 528 whereupon processing compares the extracted versions with the existing software version (step 530). A determination is made as to whether device B already has the most recent version (decision 540). If device B already has the most recent version, decision 540 branches to “Yes” branch 542 whereupon processing bypasses download requesting steps.

On the other hand, if device B does not have the most recent version, decision 540 branches to “No” branch 548 whereupon processing requests a software download from responding device A 110 (step 550). At step 560, processing receives the software download from responding device A 110. At step 570, processing updates the version control table that is located in device B version control table store 140 to reflect the most recent software download.

A determination is made as to whether there more software identifiers to process that are included in the query response (decision 580). If there are more software identifiers to process, decision 580 branches to “Yes” branch 582 whereupon processing selects (step 595) and processes the next software identifier. This looping continues until there are no more software identifiers to process, at which point decision 580 branches to “No” branch 588 whereupon processing returns at 599.

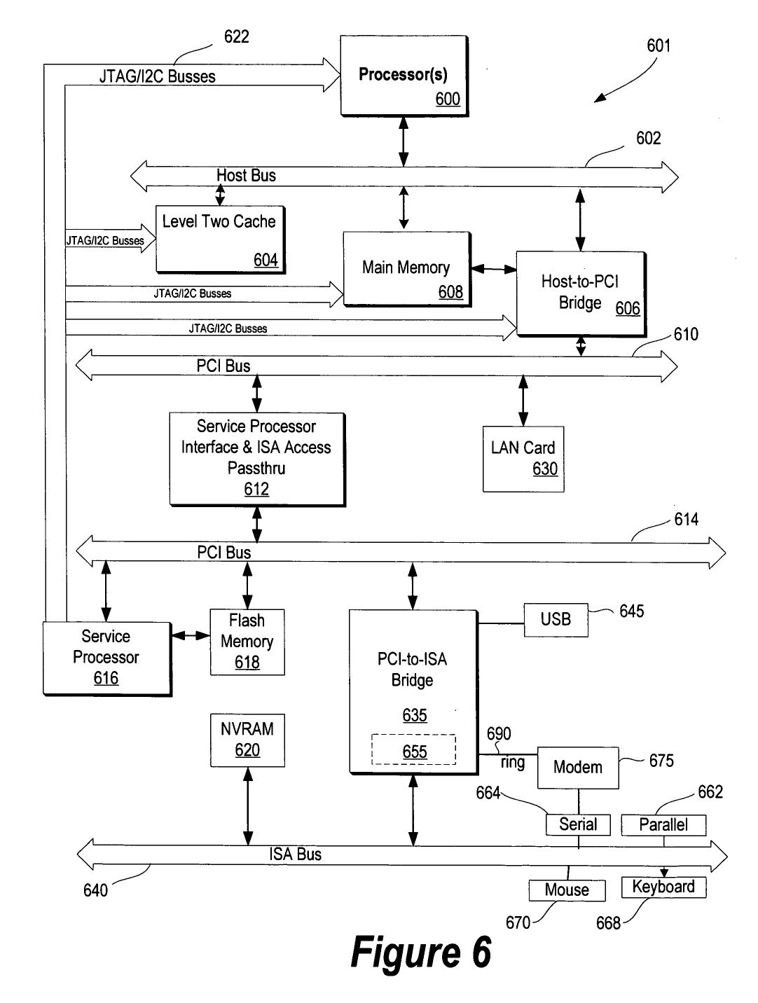

FIG. 6 illustrates information handling system 601 which is a simplified example of a computer system capable of performing the computing operations described herein. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608 is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and I2C busses 622 for communication with processor(s) 600 during initialization steps. JTAG/I2C busses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
discovering a wireless responding device in a personal area network;
receiving software data from the wireless responding device;
comparing the received software data with one or more software version entries; and
downloading software from the wireless responding device corresponding to the software data in response to the comparing.

2. The method of claim 1 wherein the software data includes one or more software identifiers and one or more corresponding software versions, the comparing further comprising:
selecting one of the software identifiers; and
matching the selected software identifier's corresponding version with one or more of the software version entries.

3. The method of claim 1 further comprising:
communicating with the wireless responding device using the downloaded software.

4. The method of claim 1 wherein the wireless responding device is adapted to identify a wireless requesting
device's capabilities and identify the software data
that corresponds to the wireless requesting device's capabilities.

5. The method of claim 4 wherein the wireless responding device is further adapted to send an error message to the wireless requesting device in response to not
identifying the wireless requesting device's capabilities.

6. The method of claim 1 wherein the comparing is performed by the wireless responding device.

7. The method of claim 1 further comprising:
updating a version control table to reflect the software download.

8. A program product comprising:
computer operable medium having computer program code, the computer program code being effective to:
discover a wireless responding device in a personal area network;
receive software data from the wireless responding device;
compare the received software data with one or more software version entries; and
download software from the wireless responding device corresponding to the software data in response to the comparing.

9. The program product of claim 8 wherein the software
data includes one or more software identifiers and one or more corresponding software versions, the computer program code further effective to:
select one of the software identifiers; and
match the selected software identifier's corresponding version with one or more of the software version entries.

10. The program product of claim 8 wherein the computer program code is further effective to:
communicate with the wireless responding device using the downloaded software.

11. The program product of claim 8 wherein the wireless responding device is adapted to identify a wireless requesting device's capabilities and identify the software data that corresponds to the wireless requesting device's capabilities.

12. The program product of claim 11 wherein the wireless responding device is further adapted to send an error message to the wireless requesting device in response to not identifying the wireless requesting device's capabilities.

13. The program product of claim 8 wherein the comparing is performed by the wireless responding device.

14. The program product of claim 8 wherein the computer program code is further effective to:
update a version control table to reflect the software download.

15. An information handling system comprising:
one or more processors;
a memory accessible by the processors;
one or more nonvolatile storage devices accessible by the processors; and
a software installer tool for managing software installations, the software installer tool comprising software code effective to:
discover a wireless responding device in a personal area network;
receive software data from the wireless responding device over the personal area network;
compare the received software data with one or more software version entries located in one of the nonvolatile storage devices; and
download software over the personal area network from the wireless responding device corresponding to the software data in response to the comparing.

16. The information handling system of claim 15 wherein the software data includes one or more software identifiers and one or more corresponding software versions, the computer program code further effective to:
select one of the software identifiers; and
match the selected software identifier's corresponding version with one or more of the software version entries located in one of the nonvolatile storage devices.

17. The information handling system of claim 15 wherein the computer program code is further effective to:
communicate with the wireless responding device over the personal area network using the downloaded software.

18. The information handling system of claim 15 wherein the wireless responding device is adapted to identify a wireless requesting device's capabilities and identify the software data that corresponds to the wireless requesting device's capabilities.

19. The information handling system of claim 18 wherein the wireless responding device is further adapted to send an error message to the wireless requesting device over the personal area network in response to not identifying the wireless requesting device's capabilities.

20. The information handling system of claim 15 wherein the comparing is performed by the wireless responding device.

21. The information handling system of claim 15 wherein the computer program code is further effective to:
update a version control table located in one of the nonvolatile storage devices in order to reflect the software download.

22. A method comprising:
discovering a wireless responding device in a personal area network;
receiving software data from the wireless responding device;
comparing the received software data with one or more software version entries, the software data including one or more software identifiers and one or more corresponding software versions, the comparing further comprising:
selecting one of the software identifiers; and
matching the selected software identifier's corresponding version with one or more of the software version entries;
downloading software from the wireless responding device corresponding to the software data in response to the comparing; and
communicating with the wireless responding device using the downloaded software.

23. A program product comprising:
computer operable medium having computer program code, the computer program code being effective to:
discover a wireless responding device in a personal area network;
receive software data from the wireless responding device;
compare the received software data with one or more software version entries, the software data including one or more software identifiers and one or more corresponding software versions, the computer program code further effective to:
select one of the software identifiers; and
match the selected software identifier's corresponding version with one or more of the software version entries;
download software from the wireless responding device corresponding to the software data in response to the comparing; and
communicate with the wireless responding device using the downloaded software.

24. An information handling system comprising:
one or more processors;
a memory accessible by the processors;
one or more nonvolatile storage devices accessible by the processors; and
a software installer tool for managing software installations, the software installer tool comprising software code effective to:
discover a wireless responding device in a personal area network;
receive software data over the personal area network from the wireless responding device;
compare the received software data with one or more software version entries located in one of the nonvolatile storage devices, the software data including one or more software identifiers and one or more corresponding software versions, the software code further effective to:
select one of the software identifiers; and
match the selected software identifier's corresponding version with one or more of the software version entries;
download software over the personal area network from the wireless responding device corresponding to the software data in response to the comparing; and
communicate with the wireless responding device using the downloaded software.
